(19) United States
(12) Patent Application Publication
(10) Pub. No.: US 2017/0140406 A1
(43) Pub. Date: May 18, 2017

(54) SYSTEM AND METHOD FOR PROVIDING A MULTI-CHANNEL INVENTORY ALLOCATION APPROACH FOR RETAILERS

(71) Applicant: ORACLE INTERNATIONAL CORPORATION, Redwood Shores, CA (US)

(72) Inventors: David R. ANDERSON, Saint Paul, MN (US); John S. BIBLE, Belmont, MA (US); Patrick J. BOHANNON, Aurora, IL (US)

(21) Appl. No.: 14/941,785

(22) Filed: Nov. 16, 2015

(51) Int. Cl. G06Q 30/02; G06Q 10/08

(52) U.S. Cl. CPC G06Q 30/0206; G06Q 10/087

(57) ABSTRACT

Systems, methods, and other embodiments are disclosed that are configured to maximize expected net revenue for a retail item. In one embodiment, input data associated with a retail item is read. A total inventory amount for the retail item that is available for distribution is initially allocated across sales channels where the retail item is sold to form a plurality of allocated inventory amounts, as represented in an inventory allocation data structure. An attempt is made to equalize marginal revenue values associated with the retail item across the sales channels as represented in a marginal revenue data structure. The allocated inventory amounts are iteratively adjusted, and marginal revenue values are iteratively updated based on the input data and the adjusted allocated inventory amounts for the sales channels. As the updated marginal revenue values approach equalization across the sales channels, the expected net revenue approaches maximization.

### BACKGROUND

Today, retailers often buy fixed amounts of inventory and divide the inventory across locations and channels to sell the inventory. For example, a retailer with a web site and one-hundred stores may have to determine how much inventory to reserve for web sales and how much to send to each store for each individual type of retail item bought. The retail industry has traditionally focused on allocating units of inventory based on demand. Also, inventory has traditionally been split between stores such that each location's inventory level is proportional to its demand.

However, some retailers have used a “priority matrix” approach to allocate inventory. A priority matrix may be used to allocate inventory based on priorities assigned to different types of demand and to different stores. For example, a priority matrix may assign backorders the highest priority, presentation stock a secondary priority, and safety stock a tertiary priority. Therefore, the priority matrix would allocate inventory across stores based on demand priority first and store priority second.

Thus, the retail industry has focused on distributing inventory across stores in proportion to demand, or for different demand purposes. Such demand-focused approaches made sense when most locations were similar. However, such approaches are inadequate now that retailers have multiple channels and make extensive use of localization.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with revenue maximization logic which includes inventory allocation logic;

FIG. 2 illustrates one embodiment of a method, which can be performed by the revenue maximization logic of the computer system of FIG. 1, for allocating a total available inventory for a retail item across sales channels which results in maximizing an expected net revenue for the retail item; and

FIG. 3 illustrates one embodiment of a computing device upon which revenue maximization logic of a computing system may be implemented.

### DETAILED DESCRIPTION

Systems, methods, and other embodiments are disclosed for figuring out how to allocate inventory of a retail item across multiple sales channels in an attempt to maximize revenue expected to be generated by expected sales of the retail item. New types of data are taken into consideration, including cross-sell opportunity, customer-specific average revenue per unit (ARPU), store-level prices, and channel-specific shipping costs. Differences in statistical demand patterns across sales channels are also taken into consideration. Example embodiments are discussed herein with respect to computerized retail management, where revenue factor data, statistical demand data, and current inventory levels are taken into consideration.

In one embodiment, revenue maximization logic is disclosed that is configured to take into account an interesting mathematical relationship. The mathematical relationship indicates that the expected revenue for a retail item can be maximized when inventory for the retail item is allocated across sales channels in such a manner that marginal revenue values for the retail item are equalized across the sales channels. An iterative approach is described herein which allows a system to home in on the revenue-maximizing allocation of inventory.

The following terms are used herein with respect to various embodiments.

The term “item” or “retail item”, as used herein, refers to merchandise to be sold, purchased, and/or returned in a sales environment.

The term “sales channel” or “location”, as used herein, may refer to a physical store or location where an item is sold, or to an on-line store via which an item is sold. The terms “sales channel” and “location” are used interchangeably herein.

The term “net revenue factor”, as used herein, refers to the lifetime value of expected net revenue generated from a sale of a retail item via a sales channel. The net revenue factor depends on parameters such as, for example, the price of the retail item at the sales channel, the cross-sell opportunity at the sales channel, and full per unit cost of the retail item at the sales channel. Cross-sell opportunities include expected sales of additional physical merchandise and expected sales of services such as, for example, network services contracts for a telecom entity or service plans for an electronics retailer.

The term “statistical demand”, as used herein, refers to the likelihood of a retail item to be sold as represented, for example, by a demand distribution function (i.e., the probability of different levels of demand actually occurring).

The term “total available inventory”, as used herein, refers to the number of units of a retail item that is available to be distributed (allocated) across multiple sales channels.

The term “marginal revenue”, as used herein, refers to the additional incremental amount of revenue that is expected to be generated due to an incremental change in an inventory amount of a retail item at a sales channel.

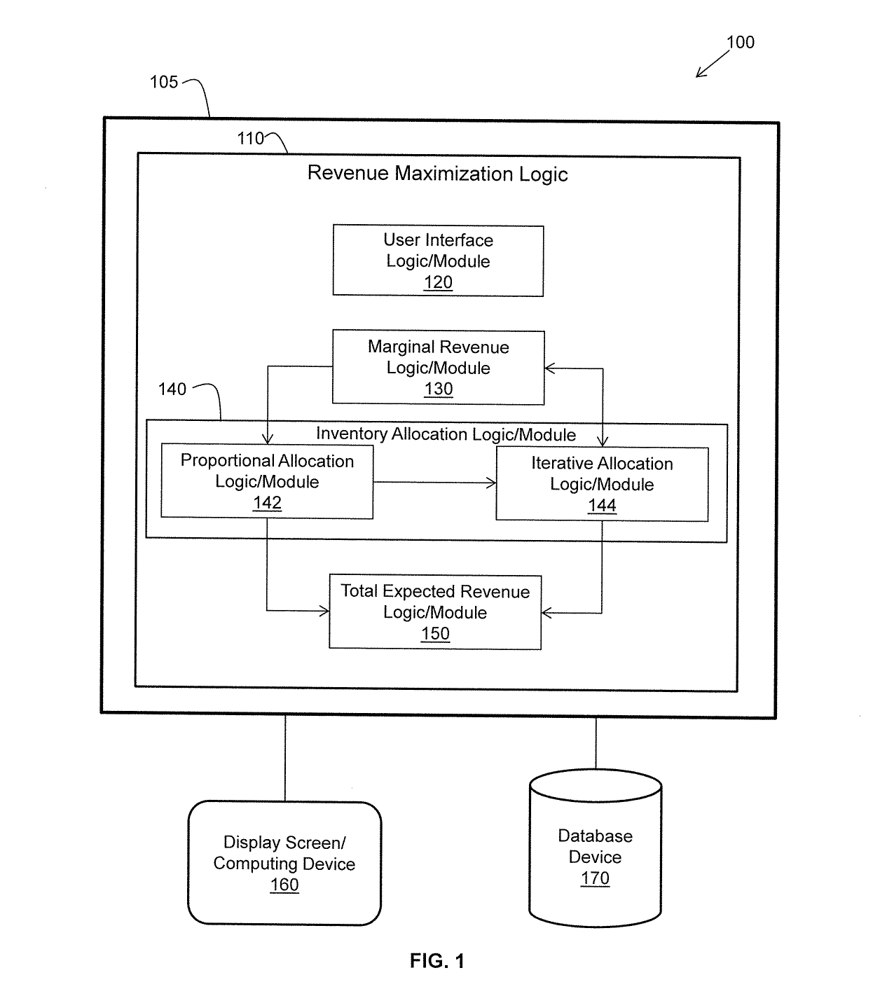

FIG. 1 illustrates one embodiment of a computer system 100, having a computing device 105 configured with revenue maximization logic 110. For example, in one embodiment, revenue maximization logic 110 may be part of a larger computer application configured to forecast and manage sales, promotions, and inventory for retail items at various retail locations. Revenue maximization logic 110 is configured to computerize the process of analyzing data to allocate inventory of a retail item so as to maximize expected revenue. In one embodiment, the software and computing device 105 may be configured to operate with or be implemented as a cloud-based networking system, a software-as-a-service (SaaS) architecture, or other type of computing solution.

A problem facing retailers is that of allocating a fixed amount of inventory across sales channels to generate the most net revenue over a specific period of time given uncertain demand. The problem can be described mathematically as maximizing expected net revenue from sales over a period of time given demand patterns and revenue factors, subject to a constraint on available inventory. The problem can be expressed as follows:

$${max}_{{v}_{1} , {v}_{2} , … {v}_{n}} {\sum }_{i = 1}^{N} {r}_{i} * [ {\int }_{0}^{{z}_{i} + {v}_{i}} {xf}_{i} ( x ) d x + {\int }_{{z}_{i} + {v}_{i}}^{∞} ( {z}_{i} + {v}_{i} ) {f}_{i} ( x ) d x ] , \\ subject to {\sum }_{i = 1}^{N} {v}_{i} = V , \\ and {v}_{i} ≧ 0 for all i .$$

where:

N is the total number of locations sales channels to allocate inventory,

i is the index for the locations,

zᵢ is the initial inventory on hand at Location i,

V is the total amount of inventory available during the period,

vᵢ is the inventory to be allocated to Location i,

r₁ is the net revenue factor for Location i, and

fᵢ is the demand distribution function during the period for Location i.

Note that the net revenue factor for Location i is the lifetime value of expected net revenue that will be generated from a sale of the item at that location. The net revenue factor depends on, for example, the price of the item at the location, the cross-sell opportunity at the location, and full per unit cost at the location. Cross-sell opportunities include expected sales of additional physical merchandise and expected sales of services such as network services contracts for a telecom entity or service plans for an electronics retailer. The net revenue factor also accounts for differences in the expected unit cost of the merchandise due to location-specific logistical costs.

One embodiment accounts for two factors that make allocating inventory in proportion to demand sub optimal. The two factors are differences in expected net revenue per unit and differences in relative demand variability. The approach herein solves the problem by developing an iterative algorithm that finds the inventory levels that satisfy the optimality conditions. The optimality conditions account for differences in total net revenue per unit sold and differences in demand patterns. The optimality conditions apply to any continuous demand distribution. The approach also calculates the expected increase in revenue that will result from the optimal allocation compared to the proportionate allocation.

The telecommunications industry provides a good example of how the allocation approach described herein may provide significant benefit with respect to increasing revenue. A telecommunications company may have many sales channels including many physical stores as well as an on-line presence. Furthermore, the telecommunications company may deal with many thousands of units of, for example, a particular type of mobile telephone every day. Computerizing the inventory allocation process is likely the only feasible way to have a chance of allocating inventory in such a manner that maximizes revenue.

In the telecommunications industry, the technique of customer value banding is often used to segment the customer population into groups that share similar qualities. For example, one banded group may include wealthy and well-traveled business men who tend to use expensive smart phones and associated accessories. Another banded group may include teenage girls who tend to use less expensive smart phones and accessories. Furthermore, certain sales channels may be highly correlated to one banded group and other sales channels may be highly correlated to another banded group.

In one embodiment, such customer value bands are taken into account when attempting to allocate available inventory to maximize revenue across the sales channels. For example, in one embodiment, customer value bands are taken into consideration as part of the net revenue factor. In another embodiment, a separate factor may be introduced which takes into consideration the customer value bands. Therefore, a telecommunications company can forego allocation of inventory to sales channels that simply demonstrate a basic need to those sales channels that will serve the highest banded customers. In this manner, customer effects are rolled into the solution space and provide for a significantly better chance of maximizing revenue.

The optimality conditions send more inventory to stores with higher expected net revenue factors. Certain locations can usually be expected to generate more net revenue per sales unit based on differences in pricing or historic cross-sell. For example, stores selling phone handsets in central business districts with more business users may have higher services Average Revenue per User (ARPU) than stores in other areas. Delivering more handsets to stores that generate higher average revenue per unit will help allocate handsets to the customers who value them most and will help increase revenue for the retailer.

Furthermore, the optimality conditions send more inventory to stores with lower relative sales variability. Increasing inventory in stores with lower relative sales variability increases revenue because these stores will be more likely to sell the inventory they receive than stores with higher sales variability in the case when inventory is too low to meet expected demand. Differences in relative sales variability across stores are common. Usually, larger stores have lower relative sales variability than smaller stores and should receive relatively more inventory than smaller stores. For multi-channel retailers, a web channel can have the demand characteristics of an extremely large store with much lower demand variability than physical stores.

In accordance with one embodiment, the algorithm used to implement the optimization conditions uses the normal distribution to model demand patterns. The normal distribution is fit to item/location level demand using mean sales and the standard deviation of sales. The algorithm solves the optimization conditions by iteratively searching over different inventory allocation levels. At each iterative step, a weighted average value of the marginal revenue of an additional inventory unit is estimated, and then the level of inventory for each sales channel that achieves that marginal revenue is calculated. The weighted average marginal revenue value is weighted by the total available inventory amount.

For some sales channels, the level of inventory calculated may be negative, which means that no inventory should be sent to that sales channel. A complete iteration of the approach averages inventory across the previous two marginal revenue equalization steps. The averaging can help speed up the algorithm in cases where the single steps oscillate slowly towards the optimal allocation.

In one embodiment, the algorithm stops searching for an improved solution when a difference in inventory levels between iterations becomes small enough, or when the maximum number of iterations is reached. After the optimal allocation is found, the algorithm computes the benefits of using the optimal allocation compared to a proportionate allocation. Knowing these benefits can help retailers to understand the importance of using the optimal allocation compared to a proportionate allocation.

With reference to FIG. 1, in one embodiment, revenue maximization logic/module 110 is implemented on the computing device 105 and includes logics for implementing various functional aspects of the revenue maximization logic/module 110. In one embodiment, revenue maximization logic/module 110 includes user interface logic/module 120, marginal revenue logic/module 130, inventory allocation logic/module 140, and total expected revenue logic/module 150. In one embodiment, inventory allocation logic/module 140 includes proportional allocation logic/module 142 and iterative allocation logic/module 144.

The computer system 100 also includes a display screen 160 operably connected to the computing device 105. In accordance with one embodiment, the display screen 160 is implemented to display views of and facilitate user interaction with a graphical user interface (GUI) generated by the user interface logic 120 for viewing and updating information associated with optimal inventory allocation. The graphical user interface may be associated with a revenue maximization application and the user interface logic 120 may be configured to generate the graphical user interface. In one embodiment, the revenue maximization logic 110 is a centralized server-side application that is accessed by many client devices/users. Thus the display screen 160 may represent multiple computing devices/terminals that allow users to access and receive services from the revenue maximization logic 110 via networked computer communications.

In one embodiment, the computer system 100 further includes at least one database device 170 operably connected to the computing device 105 and/or a network interface to access the database device 170 via a network connection. For example, in one embodiment, the database device 170 is operably connected to the user interface logic 120. In accordance with one embodiment, the database device 170 is configured to store and manage data structures (e.g., records of revenue factor data, statistical demand data, and inventory level data) associated with revenue maximization logic 110 in a database system (e.g., a computerized retail management application).

Other embodiments may provide different logics or combinations of logics that provide the same or similar functionality as revenue maximization logic 110 of FIG. 1. In one embodiment, revenue maximization logic 110 is an executable application including algorithms and/or program modules configured to perform the functions of the logics. The application is stored in a non-transitory computer storage medium. That is, in one embodiment, the logics of revenue maximization logic 110 are implemented as modules of instructions stored on a computer-readable medium.

Referring back to the logics of revenue maximization logic 110 of FIG. 1, in one embodiment, user interface logic 120 is configured to generate a graphical user interface (GUI) to facilitate user interaction with revenue maximization logic 110. For example, user interface logic 120 includes program code that generates and causes the graphical user interface to be displayed based on an implemented graphical design of the interface. In response to user actions and selections via the GUI, associated aspects of revenue maximization records and parameters for retail items may be manipulated.

For example, in one embodiment, user interface logic 120 is configured to facilitate receiving inputs and reading data in response to user actions. For example, user interface logic 120 may facilitate selection and reading of retail data (e.g., revenue factor data, statistical demand data, current inventory level data) associated with a retail item sold across multiple sales channels. The retail data may reside in at least one data structure (e.g., within database device 170) associated with (and accessible by) a revenue maximization application (e.g., revenue maximization logic 110) via the graphical user interface. The retail data (when available) for a retail item may be accessed via network communications. The maximization of expected net revenue for the retail item may be based at least in part on the retail data.

Furthermore, user interface logic 120 is configured to facilitate the outputting and displaying of output data via the graphical user interface on the display screen 160. Output data may include, for example, inventory allocation data, a number of iterations performed, a change in allocation for the final iteration, and the expected revenue from the final allocation. Other types of output data are possible as well, in accordance with various other embodiments.

Referring again to FIG. 1, in one embodiment, marginal revenue logic 130 is configured to generate a marginal revenue value for each sales channel of multiple sales channels where a retail item is sold. As a result, marginal revenue logic 130 forms a plurality of marginal revenue values. The marginal revenue values are generated based on, for example, revenue factor data, statistical demand data, and inventory amounts associated with the retail item. In accordance with one embodiment, the optimality condition for maximizing expected revenue for a retail item is that the marginal revenues for all sales channels for the retail item are equalized. Such equalization may be expressed as:

marginal_revenue;=marginal_revenueⱼ, or

rᵢ*[1−Fᵢ(zᵢ+vᵢ)]=rⱼ*[1−Fⱼ(zᵢ+vⱼ)],

for all sales channels i and j where Fᵢ is the cumulative distribution function (CDF) for the probability density function fᵢ (statistical demand) at sales channel i, rᵢ is the net revenue factor for sales channel i, zᵢ is the current inventory level of the retail item at sales channel i, and vᵢ is the new inventory amount to be allocated to sales channel i.

When an internal solution is not feasible, the optimality condition cannot be solved for all sales channels at a positive inventory value. In such a case, no inventory amount should be allocated to sales channels that have a value of the optimality condition that is less than the value for the sales channels that receive positive inventory amounts.

In one embodiment, inventory allocation logic 140 includes proportional allocation logic 142 and iterative allocation logic 144. Proportional allocation logic 142 is configured to allocate the total available inventory amount for the retail item across the multiple sales channels in proportion to an initial marginal revenue value for each sales channel. The initial marginal revenue value for each sales channel may be determined by marginal revenue logic 130 based on revenue factor data, statistical demand data, and current inventory level data for the retail item at each sales channel, in accordance with one embodiment.

In one embodiment, iterative allocation logic 144 is configured to attempt to equalize the plurality of marginal revenue values across the multiple sales channels to maximize an expected net revenue value for the retail item. For example, as discussed above, proportional allocation logic 142 may initially allocate a total available inventory amount for the retail item across the multiple sales channels to form a plurality of allocated inventory amounts, in accordance with one embodiment. Then iterative allocation logic 144 can perform an iterative process to iteratively transform or adjust the plurality of allocated inventory amounts, while maintaining the total available inventory amount. Iterative allocation logic 144 provides the plurality of allocated inventory amounts to marginal revenue logic 130, for each iteration of the iterative process, such that marginal revenue logic 130 can update the marginal revenue values.

The iterative process may continue, ideally, until the marginal revenue values are equalized across the multiple sales channels. However, realistically, achieving absolute equalization may not always be possible. In accordance with one embodiment, the iterative process is continued until at least one iteration criterion has been met, as determined by iterative allocation logic 144. For example, the iterative process may continue until a defined maximum number of iterations has been reached. Alternatively, the iterative process may continue until a difference in a total change of the plurality of allocated inventory amounts between a current iteration and a previous iteration is less than a threshold value.

In one embodiment, total expected revenue logic 150 is configured to generate a total expected net revenue value for the retail item across the multiple sales channels based at least in part on the plurality of allocated inventory amounts. The total expected net revenue value may be generated after the iteration criterion has been met (i.e., once the final allocated inventory amounts are determined). Alternatively, or in addition, the total expected net revenue value may be generated immediately before the iterative process is started (i.e., based on the initial allocation of the total available inventory amount for the retail item).

In this manner, revenue maximization logic 110 (e.g., implemented as part of a larger computer application) can allocate a total available inventory amount for a retail item across multiple sales channels so as to maximize expected net revenue for the retail item over a period of time. As a result, using such revenue maximization logic 110, a retailer may more intelligently allocate available inventory for a retail item. The ability to intelligently allocate available inventory in this manner may become especially important in the short-run, when it is known that there is a shortage of product and the retailer is trying to get through the shortage period as best as possible.

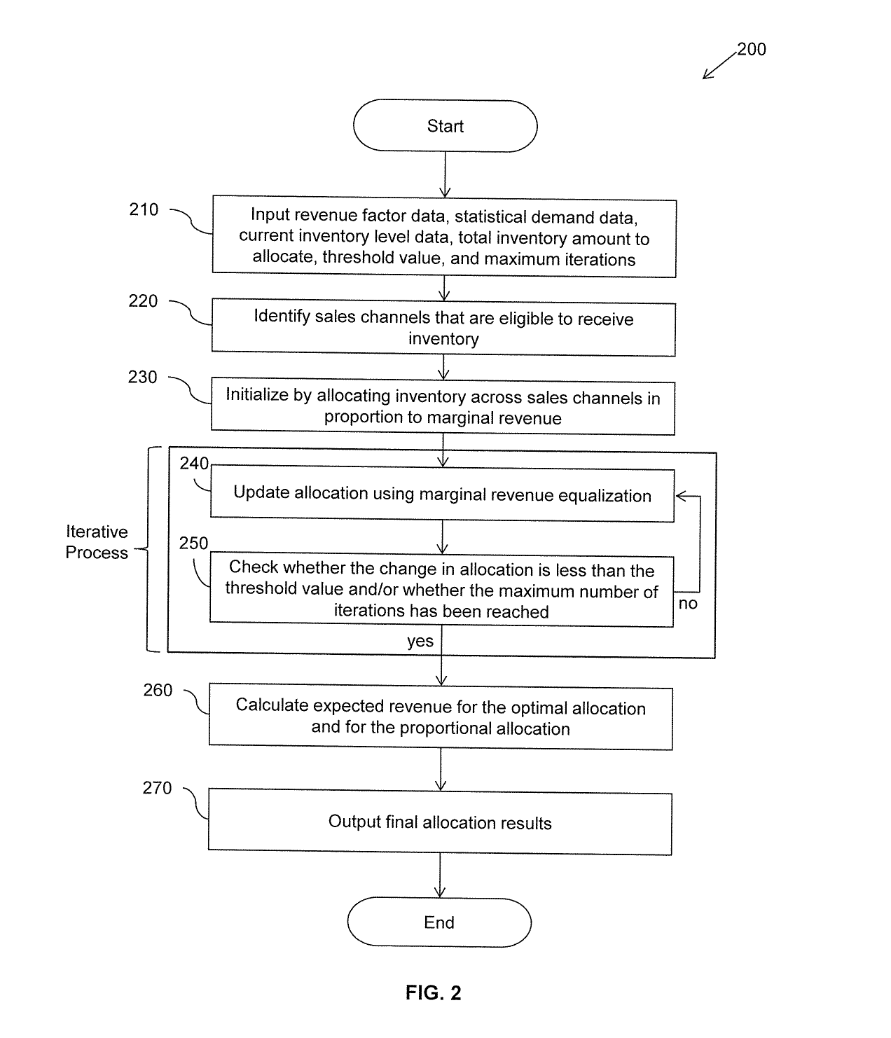

FIG. 2 illustrates one embodiment of a computer-implemented method 200 for allocating available inventory of a retail item to maximize expected net revenue. Method 200 describes operations of revenue maximization logic 110 and is implemented to be performed by revenue maximization logic 110 of FIG. 1, or by a computing device configured with an algorithm of the method 200. For example, in one embodiment, method 200 is implemented by a computing device configured to execute a computer application. The computer application is configured to process data in electronic form and includes stored executable instructions that perform the functions of method 200 and/or its equivalents.

Method 200 will be described from the perspective that, for an item (e.g., a retail item) sold at various locations (e.g., sales channels), newly acquired inventory for the item becomes available at different times and is to be allocated across the various sales channels. Instead of simply allocating the new inventory based simply on, for example, demand at each sales channel, a smarter approach is taken which attempts to maximize expected net revenue. Method 200 assumes that certain types of retail data are available (e.g., from a database device) for processing. The retail data may include, for example, revenue factor data, statistical demand data, and current inventory level data for each sales channel where a retail item is sold.

Upon initiating method 200, at block 210, retail data is input (e.g., read or loaded into) to an input data structure of revenue maximization logic 110. In accordance with one embodiment, at least one data structure having input data associated with a retail item is read. The input data may include revenue factor data, statistical demand data, and current inventory level data for each sales channel of multiple sales channels where the retail item is sold. More particularly, the input data may include location-level information for inventory on hand, expected lifetime net revenue, mean sales, and the standard deviation of sales.

Furthermore, the input data may also include a total available inventory amount to be allocated, a maximum number of iterations to run, and a change threshold value for stopping the iterative process. It is assumed herein that the total available inventory amount is positive. Furthermore, in accordance with one embodiment, values that have been determined to work well as convergence criteria for the iterative process include a value of ten (10) for the maximum number of iterations and a value of 0.1% for the change threshold value. In accordance with one embodiment, referring to FIG. 1, the retail data may be read from the database device 170 by revenue maximization logic 110 as facilitated by user interface logic 120. For example, user interface logic 120 may address a memory of the database device 170 to read the retail data from a data structure stored in the memory of the database device 170. User interface logic 120 may then address a memory of the computing device 105 and store the retail data in the memory of the computing device 105.

At block 220, sales channels are identified that are eligible to receive new inventory. Sales channels are eligible to receive inventory if they have positive mean sales, positive standard deviation of sales, and positive lifetime revenue values, in accordance with one embodiment. Sales channels with zero or negative values for any of the three quantities mentioned immediately above herein will not be run through the allocation process. All other sales channels are to be run through the allocation process. In accordance with one embodiment, user interface logic 120 is configured to determine which sales channels are eligible to receive inventory.

At block 230, the total available inventory amount is initially allocated across the eligible sales channels in proportion to marginal revenue to form a plurality of allocated inventory amounts represented within an inventory allocation data structure. The initial marginal revenue for each sales channel i at the initial inventory level zᵢ is determined as rᵢ*[1−Fᵢ(zᵢ)], where rᵢ is the lifetime revenue factor and Fᵢ(zᵢ) is the value of the CDF of the normal distribution for the sales channel when demand is at the initial inventory level. In accordance with one embodiment, the initial allocation is performed by proportional allocation logic 142.

The total available inventory amount is split between eligible locations in proportion to the initial marginal revenue values such that the allocated inventory level vᵢ for sales channel i is represented by:

vᵢ=V*rᵢ*[1−Fᵢ(zᵢ)]/Σ_{jεΣ}rⱼ*[1−Fⱼ(zᵢ)],

where E is the set of eligible sales channels. In accordance with other embodiments, the total available inventory amount may be initially allocated across the eligible sales channels in accordance with some other criterion (not proportional to marginal revenue).

At block 240, an iterative process is begun that attempts to update the allocation of the total available inventory amount across the sales channels such that marginal revenue is equalized (i.e. using a marginal revenue equalization technique). At block 250, a check is made as to whether a total change of the allocation amounts across the sales channels is less than a change threshold value and/or whether the maximum number of iterations has been reached. Elaborating on block 250, the change threshold value may be calculated as Σ_{iεΣ}|v_{ic}−vᵢₚ|/V, is the current inventory allocation for Location i and vᵢₚ is the previous inventory allocation for Location i. Blocks 240 and 250 constitute an iterative process that attempts to converge on the allocation amounts across the sales channels that equalize the resultant marginal revenue values. Again, equalizing the marginal revenue values across the sales channels results in maximizing the expected net revenue for the retail item. In accordance with one embodiment, blocks 240 and 250 are performed by iterative allocation logic 144 in cooperation with marginal revenue logic 130.

Elaborating on block 240, block 240 equalizes marginal revenue using the initial inventory level determined in block 230, or the inventory level determined from the previous iteration. In accordance with one embodiment, block 240 proceeds according to the following sub-steps (i to vi) for eligible sales channels (locations):
i. Calculate marginal revenue for each Location i given its current allocation, zᵢ+vᵢ, as MRᵢ=0 if vᵢ=0 and MRᵢ=rᵢ*[1−Fᵢ(zᵢ+vᵢ)] otherwise.
ii. Calculate the weighted average marginal revenue across all eligible locations as:

$$\overline{MR} = \frac{{Σ}_{j ∈ E} ( {z}_{i} + {v}_{j} ) * {MR}_{j}}{{Σ}_{j ∈ E} ( {z}_{j} + {v}_{j} )}$$

iii. Calculate a lookup value for each Location i which is 1−M̅R̅/rᵢ.
iv. Calculate the total inventory level, tᵢ, that would achieve M̅R̅ for each Location i. Define tᵢ as zᵢ if the lookup value is less than or equal to 0. If the lookup value is positive then define tᵢ as the maximum of zᵢ and the inverse of the Normal demand distribution for Location i at the lookup value.
v. Define the initial inventory to allocate to Location i as q₁ where q₁=tᵢ−z_{L}.
vi. Rescale the inventory in proportion to the output of sub-step v so that Location i receives inventory equal to V*qᵢ/Σ_{jεΣ}q₁=vᵢ.

Sub-steps i to vi are iteratively repeated, using the output inventory allocation from the previous iteration as the initial inventory allocation and effectively drives the marginal revenue value for each sales channel toward the weighted average marginal revenue value for each iteration of the iterative process. Furthermore, in one embodiment, the iterative process averages the output of the current iteration and the previous iteration to speed up convergence in cases where inventory levels oscillate around the optimal value.

In summary for blocks 240 and 250, an attempt is made to equalize marginal revenue values associated with the retail item across multiple eligible sales channels to maximize an expected net revenue value for the retail item. An iterative process is performed that adjusts (transforms) the allocated inventory amounts for each iteration of the iterative process. An updated marginal revenue value is generated for each eligible sales channel, at each iteration of the iterative process, based at least in part on the current allocated inventory amounts as adjusted.

At block 260, a first total expected net revenue value is generated for the retail item across the sales channels based at least in part on the resultant allocated inventory amounts after the iterative process is complete. Furthermore, a second total expected net revenue value is generated for the retail item across the sales channels based at least in part on the initial allocated inventory amounts that are proportional to initial marginal revenue. In accordance with one embodiment, block 260 is performed by total expected revenue logic 150.

In accordance with one embodiment, at block 260, expected net revenue is calculated as the lifetime revenue times expected sales minus expected lost sales. Expected sales are input in block 210. Expected lost sales are calculated using a lookup value. Expected lost sales depend on the number of standard deviations from the mean of the inventory level. The number of standard deviations from the mean is calculated for Location i as (zᵢ+vᵢ−μᵢ)/σTᵢ. A special lookup table is used to estimate expected lost sales and the final lost sales estimate is the value found in the lookup table times standard deviation, σᵢ.

At block 270, final allocation results are output (e.g., to an output data structure). The outputs include the final allocation obtained, the proportionate allocation, the number of iterations that were run, the change in allocation for the final iteration, and the expected revenue from the final allocation and the proportionate allocation. In accordance with one embodiment, block 270 is performed by user interface logic 120. For example, user interface logic 120 may address a memory of the computing device 105 and store the final allocation results to an output data structure stored in the memory of the computing device 105.

In this manner, a revenue maximization and inventory allocation system can use this information to optimally distribute a total available inventory amount across sales channels for a retail item. Net revenue can be significantly increased for retailers because a realistic expression of the revenue optimization problem is being solved. Customer service can be improved by shifting inventory to locations with more reliable demand. Higher revenue can be achieved by shifting inventory to locations with higher prices or higher cross-sell opportunity.

Systems, methods, and other embodiments have been described for maximizing net revenue for a retail item that is sold across a plurality of sales channels. Marginal revenue logic is configured to generate a marginal revenue value for each sales channel, forming a plurality of marginal revenue values, based at least in part on revenue factor data, statistical demand data, and inventory amounts associated with the retail item. Inventory allocation logic is configured to attempt to equalize the plurality of marginal revenue values across the sales channels to maximize an expected net revenue value for the retail item. Inventory allocation logic initially allocates a total available inventory amount for the retail item across the sales channels to form a plurality of allocated inventory amounts. Inventory allocation logic then performs an iterative process that iteratively transforms the plurality of allocated inventory amounts. The plurality of allocated inventory amounts is provided to the marginal revenue logic, for each iteration of the iterative process, such that the marginal revenue logic can update the plurality of marginal revenue values. The iterative process is performed until an iteration criterion has been met, at which point the plurality of marginal revenue values are equalized (or nearly so).

### Computing Device Embodiment

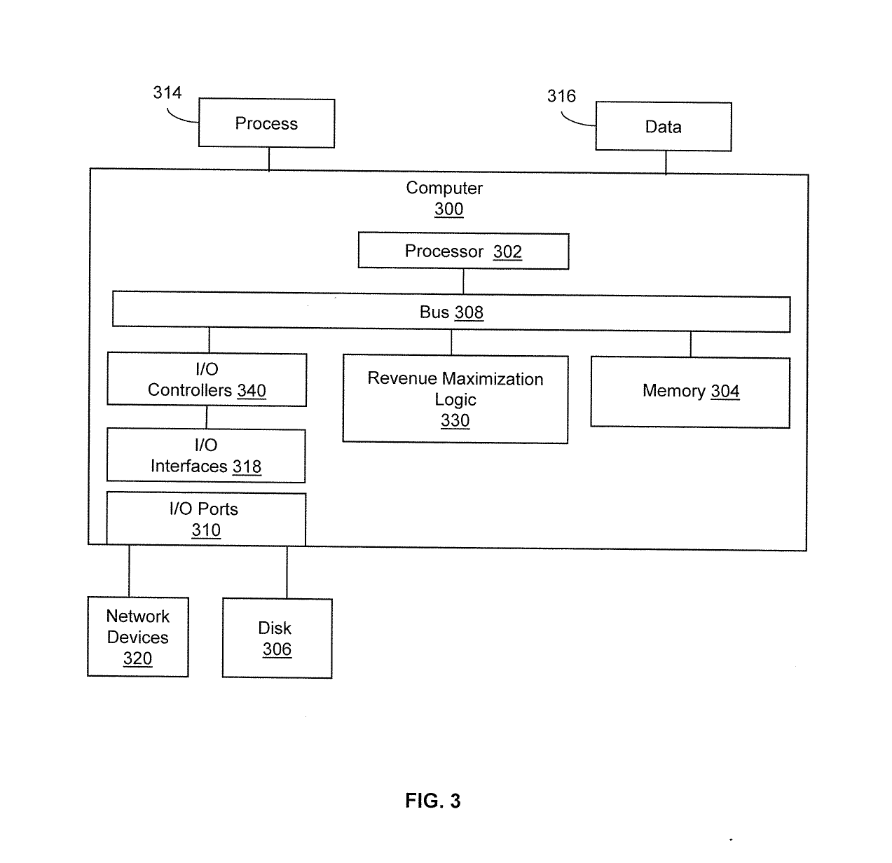

FIG. 3 illustrates an example computing device that is configured and/or programmed with one or more of the example systems and methods described herein, and/or equivalents. FIG. 3 illustrates one example embodiment of a computing device upon which an embodiment of a revenue maximization logic may be implemented to maximize revenue to be generated by the sales of a retail item. The example computing device may be a computer 300 that includes a processor 302, a memory 304, and input/output ports 310 operably connected by a bus 308.

In one example, the computer 300 may include revenue maximization logic 330 (corresponding to revenue maximization logic 110 from FIG. 1) configured with a programmed algorithm, as disclosed herein, to iteratively adjust allocated inventory amounts across sales channels for a retail item until corresponding marginal revenue values are equalized (or nearly so) across the sales channels. In different examples, the logic 330 may be implemented in hardware, a non-transitory computer-readable medium with stored instructions, firmware, and/or combinations thereof. While the logic 330 is illustrated as a hardware component attached to the bus 308, it is to be appreciated that in other embodiments, the logic 330 could be implemented in the processor 302, stored in memory 304, or stored in disk 306.

In one embodiment, logic 330 or the computer 300 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the maximization of revenue to be generated by sales of a retail item. The means may also be implemented as stored computer executable instructions that are presented to computer 300 as data 316 that are temporarily stored in memory 304 and then executed by processor 302.

Logic 330 may also provide means (e.g., hardware, non-transitory computer-readable medium that stores executable instructions, firmware) for facilitating the maximization of revenue to be generated by sales of a retail item.

Generally describing an example configuration of the computer 300, the processor 302 may be a variety of various processors including dual microprocessor and other multi-processor architectures. A memory 304 may include volatile memory and/or non-volatile memory. Non-volatile memory may include, for example, ROM, PROM, and so on. Volatile memory may include, for example, RAM, SRAM, DRAM, and so on.

A storage disk 306 may be operably connected to the computer 300 via, for example, an input/output interface (e.g., card, device) 318 and an input/output port 310. The disk 306 may be, for example, a magnetic disk drive, a solid state disk drive, a floppy disk drive, a tape drive, a Zip drive, a flash memory card, a memory stick, and so on. Furthermore, the disk 306 may be a CD-ROM drive, a CD-R drive, a CD-RW drive, a DVD ROM, and so on. The memory 304 can store a process 314 and/or a data 316, for example. The disk 306 and/or the memory 304 can store an operating system that controls and allocates resources of the computer 300.

The computer 300 may interact with input/output devices via the i/o interfaces 318 and the input/output ports 310. Input/output devices may be, for example, a keyboard, a microphone, a pointing and selection device, cameras, video cards, displays, the disk 306, the network devices 320, and so on. The input/output ports 310 may include, for example, serial ports, parallel ports, and USB ports.

The computer 300 can operate in a network environment and thus may be connected to the network devices 320 via the i/o interfaces 318, and/or the i/o ports 310. Through the network devices 320, the computer 300 may interact with a network. Through the network, the computer 300 may be logically connected to remote computers. Networks with which the computer 300 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving that data from the memory via, for example, instruction control. Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A computer-implemented method performed by a computing device where the computing device includes at least a processor for executing instructions from a memory, the method comprising:
reading at least one input data structure having input data associated with a retail item, including revenue factor data, statistical demand data, and current inventory level data for each sales channel of a plurality of sales channels where the retail item is sold;
initially allocating a total available inventory amount for the retail item across the plurality of sales channels to form a plurality of allocated inventory amounts represented within an inventory allocation data structure; and
attempting to equalize marginal revenue values associated with the retail item across the plurality of sales channels to maximize an expected net revenue value for the retail item by performing an iterative process that:
(i) adjusts the plurality of allocated inventory amounts within the inventory allocation data structure for each iteration of the iterative process, and
(ii) generates an updated marginal revenue value, within a marginal revenue data structure, for each sales channel of the plurality of sales channels for each iteration of the iterative process based at least in part on the input data and the plurality of allocated inventory amounts as adjusted.

2. The method of claim 1, further comprising continuing the iterative process until a defined maximum number of iterations is reached.

3. The method of claim 1, further comprising continuing the iterative process until a difference in a total change of the plurality of allocated inventory amounts between a current iteration and a previous iteration is less than a threshold value stored in a data field.

4. The method of claim 1, further comprising generating a total expected net revenue value, in a data field, for the retail item across the plurality of sales channels based at least in part on the plurality of allocated inventory amounts after the iterative process is completed.

5. The method of claim 1, further comprising generating a total expected net revenue value, in a data field, for the retail item across the plurality of sales channels based at least in part on the plurality of allocated inventory amounts immediately before the iterative process is started.

6. The method of claim 1, further comprising determining that each sales channel of the plurality of sales channels is eligible to receive inventory corresponding to the retail item.

7. The method of claim 1, further comprising determining an initial marginal revenue value for the retail item, represented in the marginal revenue data structure, for each sales channel of the plurality of sales channels based at least in part on the input data, wherein initially allocating the total available inventory amount for the retail item across the plurality of sales channels is done in proportion to the initial marginal revenue value for each sales channel of the plurality of sales channels.

8. The method of claim 1, further comprising generating a weighted average marginal revenue value, in a data field, across the plurality of sales channels for each iteration of the iterative process, wherein the weighted average marginal revenue value is weighted by the total available inventory amount.

9. The method of claim 8, wherein each iteration of the iterative process includes adjusting each allocated inventory amount of the plurality of allocated inventory amounts by driving the marginal revenue value for each sales channel of the plurality of sales channels toward the weighted average marginal revenue value.

10. A computing system, comprising:
a marginal revenue module, including instructions stored in a non-transitory computer-readable medium, configured to generate a marginal revenue value for each sales channel of a plurality of sales channels where a retail item is sold, forming a plurality of marginal revenue values, based at least in part on revenue factor data, statistical demand data, and inventory amounts associated with the retail item; and
an inventory allocation module, including instructions stored in a non-transitory computer-readable medium, configured to attempt to equalize the plurality of marginal revenue values across the plurality of sales channels to maximize an expected net revenue value for the retail item by:
(i) initially allocating a total available inventory amount for the retail item across the plurality of sales channels to form a plurality of allocated inventory amounts,
(ii) performing an iterative process to iteratively transform the plurality of allocated inventory amounts, and
(iii) providing the plurality of allocated inventory amounts to the marginal revenue module, for each iteration of the iterative process until an iteration criterion has been met, for updated generation of the plurality of marginal revenue values.

11. The computing system of claim 10, wherein the inventory allocation module is configured to determine that the iteration criterion has been met by determining that a defined maximum number of iterations has been reached.

12. The computing system of claim 10, wherein the inventory allocation module is configured to determine that the iteration criterion has been met by determining that a difference in a total change of the plurality of allocated inventory amounts between a current iteration and a previous iteration is less than a threshold value.

13. The computing system of claim 10, further comprising a total expected revenue module, including instructions stored in a non-transitory computer-readable medium, configured to generate a total expected net revenue value for the retail item across the plurality of sales channels based at least in part on the plurality of allocated inventory amounts after the iteration criterion has been met.

14. The computing system of claim 10, wherein the marginal revenue module is configured to generate a weighted average marginal revenue value across the plurality of sales channels for each iteration of the iterative process, wherein the weighted average marginal revenue value is weighted by the total available inventory amount.

15. The computing system of claim 14, wherein the inventory allocation module is configured to transform each allocated inventory amount of the plurality of allocated inventory amounts, for each iteration of the iterative process, by driving the marginal revenue value for each sales channel of the plurality of sales channels toward the weighted average marginal revenue value.

16. A non-transitory computer-readable medium storing computer-executable instructions that are part of an algorithm that, when executed by a computer, cause the computer to perform functions, wherein the instructions comprise:
instructions for initially allocating a total available inventory amount for a retail item across a plurality of sales channels where the retail item is sold to form a plurality of allocated inventory amounts as represented in an inventory allocation data structure;
instructions for determining a marginal revenue value for each sales channel of the plurality of sales channels, based at least in part on the plurality of allocated inventory amounts, to form a plurality of marginal revenue values for the retail item as represented in a marginal revenue data structure; and
instructions for attempting to equalize the plurality of marginal revenue values across the plurality of sales channels to maximize an expected net revenue value for the retail item by:
(i) iteratively adjusting the plurality of allocated inventory amounts across the plurality of sales channels as represented within the inventory allocation data structure, and
(ii) for each iteration, generating an updated marginal revenue value within the marginal revenue data structure for each sales channel of the plurality of sales channels based at least in part on the plurality of allocated inventory amounts as adjusted within the inventory allocation data structure.

17. The non-transitory computer-readable medium of claim 16, wherein the instructions further include instructions for generating a total expected net revenue value, in a data field, for the retail item across the plurality of sales channels based at least in part on the plurality of allocated inventory amounts.

18. The non-transitory computer-readable medium of claim 16, wherein the instructions further include:
instructions for determining an initial marginal revenue value for each sales channel of the plurality of sales channels based at least in part on an initial existing inventory of the retail item for each sales channel of the plurality of sales channels; and
instructions for initially allocating the total available inventory amount for the retail item across the plurality of sales channels in proportion to the initial marginal revenue value for each sales channel of the plurality of sales channels.

19. The non-transitory computer-readable medium of claim 16, wherein the instructions further include instructions for generating a weighted average marginal revenue value across the plurality of sales channels, in a data field, wherein the weighted average marginal revenue value is weighted by the total available inventory amount.

20. The non-transitory computer-readable medium of claim 19, wherein the instructions further include instructions for adjusting each allocated inventory amount of the plurality of allocated inventory amounts to drive the updated marginal revenue value for each sales channel of the plurality of sales channels toward the weighted average marginal revenue value.
